(19) United States
(12) Patent Application Publication
(10) Pub. No.: US 2026/0039376 A1
(43) Pub. Date: Feb. 5, 2026

(54) NON-TERRESTRIAL NETWORK DOWNLINK CO-CHANNEL INTERFERENCE MANAGEMENT ON TERRESTRIAL NETWORK DOWNLINK

(71) Applicant: DISH Wireless L.L.C., Littleton, CO (US)

(72) Inventors: Medhi Alasti, Arlington, VA (US); Sourabh Gupta, Ashburn, VA (US)

(21) Appl. No.: 18/791,759

(22) Filed: Aug. 1, 2024

(51) Int. Cl. H04B 7/185; H04L 5/00; H04W 72/541; H04B 7/204

(52) U.S. Cl. CPC H04B 7/18545; H04L 5/0073; H04W 72/541; H04B 7/2041

(57) ABSTRACT

Approaches are described herein for mitigating non-terrestrial network (NTN) downlink co-channel interference on a terrestrial network (TN) downlink. For example, for any designated times, a TN scheduler can predict locations and orientations for satellites of the NTN and their illuminated beam coverage areas. The TN scheduler can determine interference conditions for each of the designate times by determining instances in which a cell coverage area of the TN is overlapped by one or more of the beam coverage areas and in which the overlapping beam and cell use an implicated sub-band of overlapping downlink frequencies. A spectrum blanking engine can schedule TN bandwidth resources for each of the designated times based on deactivating communications in the implicated sub-bands in the implicated cells according to the interference conditions.

### BACKGROUND OF THE INVENTION

Wireless connectivity continues to evolve to meet demands for ubiquity, convenience, reliability, speed, responsiveness, and the like. For example, each new generation of cellular communication standards, such as the move from 4G/LTE (fourth generation long-term evolution) networks to 5G (fifth generation) networks, has provided a huge leap in capabilities along with new and increasing demands on the infrastructures that enable those networks to operate. For example, 5G supports innovations, such as millimeter-wave frequencies, massive MIMO (Multiple Input Multiple Output), and network slicing, which enhance connectivity for unprecedented numbers of devices and data-intensive applications.

More recently, innovations in 5G networking (and its successors) have expanded from terrestrial-based communication infrastructures to so-called non-terrestrial network (NTN) infrastructures. NTN infrastructures leverage satellites and high-altitude platforms to extend 5G coverage and capabilities, such as to serve remote and otherwise underserved areas. Effective deployment of NTN solutions can help support connectivity and applications for rural users, emergency responders, global Internet-of-Things (IoT) deployments, etc.

However, non-terrestrial communications carry complexities and design concerns that are not present in terrestrial-based communications, which can add significant technical hurdles to NTN deployments. For example, effective ground-to-satellite communications involves accounting for orbital dynamics, handovers and/or other transitions between satellites, path loss, propagation delay, atmospheric conditions, inter-satellite and/or inter-beam interference, spectrum and regulatory considerations, and other considerations. Additionally, interference concerns can arise in regions where non-terrestrial beams and terrestrial cells are communicating over the same or similar portions of spectrum. New approaches continue to be developed to find technical solutions for overcoming, or at least mitigating, these and other technical hurdles.

### BRIEF SUMMARY OF THE INVENTION

Systems and methods are described herein for mitigating non-terrestrial network (NTN) downlink co-channel interference on a terrestrial network (TN) downlink. For example, for any designated times, a TN scheduler can predict locations and orientations for satellites of the NTN and their illuminated beam coverage areas. The TN scheduler can determine interference conditions for each of the designate times by determining instances in which a cell coverage area of the TN is overlapped by one or more of the beam coverage areas and in which the overlapping beam and cell use one or more implicated sub-band of overlapping downlink frequencies. A spectrum blanking engine can schedule TN bandwidth resources for each of the designated times based on deactivating communications in the implicated sub-bands in the implicated cells according to the interference conditions.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a highly simplified communication environment.

FIG. 2 shows an example of a network environment having both non-terrestrial network (NTN) and terrestrial network (TN) portions.

FIG. 3 shows a partial communication environment that includes an illustrative embodiment of a TN scheduler, according to embodiments described herein.

FIG. 4 shows a graphical representation of an interference condition for a single cell at a single time.

FIGS. 5A – 5D show graphical representations of a changing interference condition over time for a single cell over four times.

FIG. 6 provides a schematic illustration of an embodiment of a computational system that can implement various system components and/or perform various steps of methods provided by various embodiments.

FIG. 7 shows a flow diagram of an illustrative method for mitigating NTN downlink co-channel interference on a TN downlink.

### DETAILED DESCRIPTION OF THE INVENTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the problems discussed above or might address only some of the problems discussed above. Some of the problems discussed above might not be fully addressed by any of the features described herein.

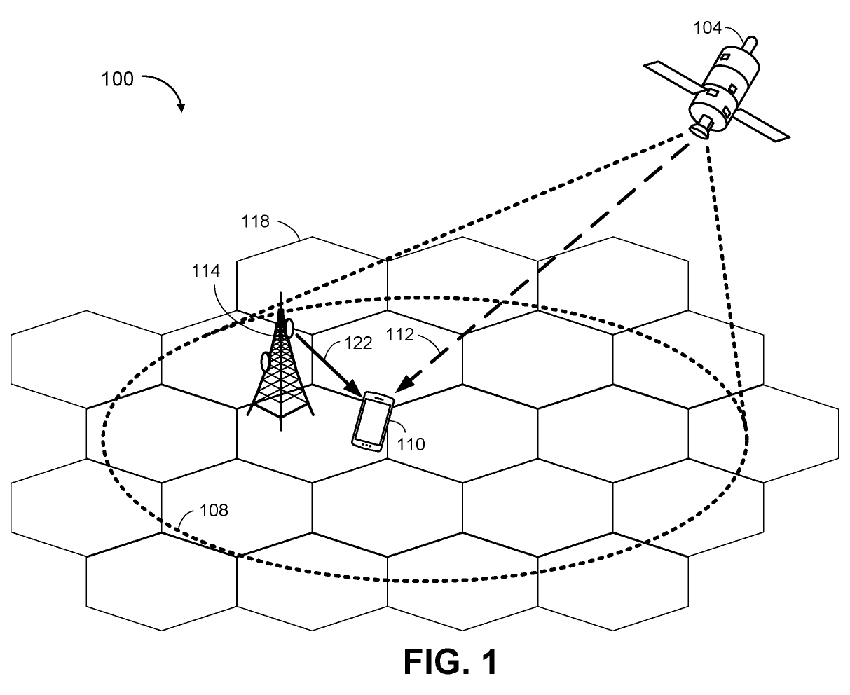

For the sake of providing context for embodiments described herein, FIG. 1 shows a highly simplified communication environment 100. The communication environment 100 includes both a non-terrestrial network (NTN) portion (e.g., including satellite network infrastructure) and a terrestrial network (TN) portion (e.g., including cellular network infrastructure). For embodiments described herein, the environment 100 is assumed to have at least some geographical regions and/or timeframes in which there is an overlap between TN communication coverage (e.g., cellular coverage) and NTN communication coverage (e.g., satellite beam coverage). The NTN portions of the network can be an NTN extension of a TN infrastructure. For example, fifth generation (5G) cellular standards support NTN extensions and define ways in which the NTN portion can be modified to implement 5G new radio (NR) protocols and other 5G concepts. In some implementations, the NTN and TN portions of the network are fully integrated. In other implementations, there is only enough integration to facilitate features described herein. For example, embodiments described herein schedule TN cell bandwidth based on a knowledge of potential downlink channel overlaps with NTN communications. Implementing such features involves enough integration so that the TN is aware of locations and frequency bands of NTN beams over time.

The illustrated environment 100 includes cells 118 produced by cell towers 114 and defining respective cell coverage areas on the surface of the Earth. Although only a single cell tower 114 is shown in the simplified illustration, a real-world deployment will have many cell towers 114. A network of cell towers 114 is strategically positioned to provide coverage across a defined geographic area, and each cell tower 114 can transmit and receive signals to and from user terminals 110 (e.g., mobile devices) within its coverage area (i.e., its cell 118). Depending on many factors (e.g., terrain, frequency band, physical obstacles, etc.), the effective communication range of a single cell tower 114 can range from only a few hundred meters to several tens of kilometers. Each cell tower 114 can typically service multiple cells 118, such as by including multiple cellular antennas, using sectorization, etc. A typical urban deployment may have a much higher density of cells 118, such as spaced 0.1 to 1.2 miles apart. Each urban cell tower 114 may serve smaller cells 118, known as microcells or picocells. A typical rural deployment may have a lower density of cells 118, such as spaced 3 to 18 miles apart, or farther. Each rural cell tower 114 typically cover larger cells 118, known as macrocells.

Although there is estimated to be over one million cell towers 114 worldwide, the cell towers 114 alone cannot provide global coverage. As noted above, recent standards (e.g., 5G) have begun to facilitate NTN extensions to those cellular networks. The illustrated environment 100 includes beams 108 produced by satellites 104. The beams 108 define respective beam coverage areas on the surface of the Earth. Although only a single satellite 104 and a single beam 108 are shown in the simplified illustration, a real-world deployment can have many satellites 104 and/or many beams 108. In some cases (and/or at some times), beams 108 and cells 118 cover different geographic areas; in other cases (and/or at other times), beams 108 and cells 118 have overlapping coverage areas. For example, the illustrated environment 100 shows a beam 108 having overlapping coverage with several cells 118. The illustrated number and sizes of the cells 118 relative to the beam 108 is not intended to be representative of an actual deployment. Depending on factors, such as population density, beam size, cell size, cell tower density, topology, etc., tens or hundreds of cells 118 can fit within a single beam coverage area.

In some implementations, the satellites 104 are geosynchronous orbit (GEO) satellites 104. For example, a typical GEO satellite can orbit the Earth at an altitude of approximately 35,786 kilometers (22,236 miles) above the equator, so that the satellite’s orbit matches the Earth's rotation, and the satellite effectively remains stationary relative to a fixed point on the Earth's surface. Each GEO satellite can typically produce large numbers (e.g., dozens, hundreds, etc.) of spot beams 108 to cover extensive geographic areas and support high-capacity data transmissions.

In other implementations, the satellites 104 are non-geosynchronous orbit (NGSO) satellites 104, such as low-Earth orbit (LEO) or medium-Earth orbit (MEO) satellites 104. LEO satellites typically orbit the Earth at altitudes ranging from 180 kilometers (112 miles) to 2,000 kilometers (1,242 miles), thereby enabling lower-latency communication services. Each LEO satellite typically produces a smaller number of beams 108, such as one beam 108, four beams 108, or even tens of beams 108. Often, such satellites 104 are deployed in constellations, sometimes including tens, hundreds, or thousands of satellites 104 to provide global coverage as they move rapidly in one or more orbits, orbital planes, etc. MEO satellites typically orbit at altitudes between 2,000 kilometers (1,242 miles) and 35,786 kilometers (22,236 miles). They are often deployed in smaller constellations, and each MEO satellite often produces a higher number of larger beams 108 than LEO satellites, so that the constellation can cover larger regions with fewer satellites 104.

As noted above, beams 108 and cells 118 can have overlapping coverage areas. The NTN portion of the network (e.g., the satellite portion) communicates using NTN frequency bands and the TN portion of the network (e.g., the cellular portion) communicates using TN frequency bands. In some deployments, NTN frequency bands can overlap with TN frequency bands. The overlaps can cause co-channel interference between the NTN and TN communications. Such interference can degrade the quality of service, reduce data throughput, cause communication disruptions for users on one or both networks, and/or cause other undesirable degradations.

Embodiments described herein are particularly focused on co-channel interference in the downlink (DL) portions of the communications; potential co-channel interference between the NTN DL 112 and the TN DL 122. Typically, the NTN DL 112 signal as received at the ground (e.g., by user terminals 110) is weaker than the TN DL 122. As one example, the satellite 104 is being used to provide broadband internet services to a rural area, while the terrestrial cell tower 114 also offers 5G cellular connectivity to portions of the same region. If both the satellite 104 and the cell tower 114 operate on the same frequency band, a user terminal 110 in the overlap zone can experience degraded service quality. For instance, a user of the user terminal 110 connected to the cell tower 114 can experience dropped calls, slow internet speeds, and or other effects due to interference from the satellite 104. As another example, in an urban environment, small cells 118 can be densely deployed to enhance 5G coverage. If the satellite beam 108 covers the same area as some of the cells 118 and operates on overlapping frequencies, the high density of terrestrial cells 118 can exacerbate the interference, leading to significant performance issues for both networks.

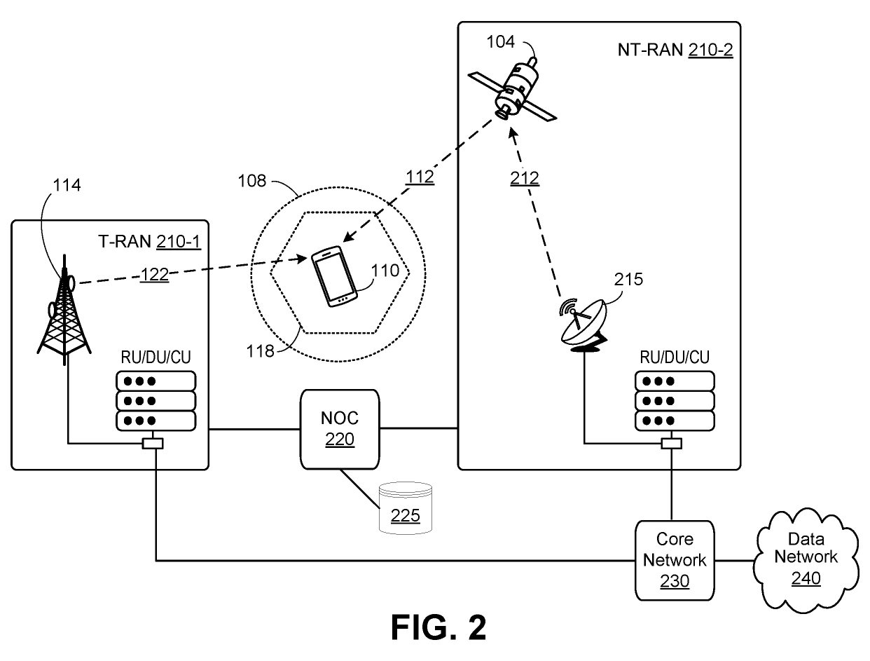

For added context, FIG. 2 shows an example of a network environment 200 having both non-terrestrial network (NTN) and terrestrial network (TN) portions. The network environment 200 can be an implementation of the network environment 100 of FIG. 1. Notably, FIG. 2 represents a type of network environment 200 in which the same operator provides both the TN and NTN services using a shared core network. Embodiments described herein can operate in such an environment 200 but are not limited to such an environment 200. For example, embodiments can similarly operate in network environments where two independent operators (a TN operator and an NTN operator) share the same spectrum, and the TN operator maintains information about satellite beam coverages, ephemeris data, and frequency band-beam mappings. Thus, FIG. 2 is intended to provide one type of context for embodiments herein.

As described with reference to FIG. 1, the NTN portion produces beams 108, and the TN portion produces cells 118. In some geographical locations and/or at some times, one or more beams 108 can overlap with one or more cells 118, potentially resulting in co-channel interference, including downlink co-channel interference. Communications with user terminals (UTs) 110 in those overlapping regions can be negatively impacted by such co-channel interference. Only a single user terminal 110 is shown located within a single cell 118 fully overlapped by a single beam 108. This is intended generally to represent any suitable number of user terminals 110 located within any suitable number of cells 118 fully or partially overlapped by any suitable number of beams 108.

As illustrated, the communication environment 200 can be considered as having two radio access networks 210: a terrestrial RAN (T-RAN) 210-1 and a non-terrestrial RAN (NT-RAN) 210-2. The T-RAN 210-1 provides wireless connectivity between UTs 110 and a core network 230. As noted above, the environment 200 of FIG. 2 shows a shared core network 230, but embodiments described herein can operate in environments having separate TN and NTN core networks. The T-RAN 210-1 can include cell towers 114 (also referred to as base stations, or gNodeBs), antennas, radio frequency (RF) transceivers, backhaul connections, and/or any other suitable components. The cell towers 114 are equipped with multiple antennas to support advanced technologies, such as sectorization, Massive MIMO (Multiple Input Multiple Output), and beamforming. Such technologies can enhance spectral efficiency and network capacity by enabling the simultaneous transmission of multiple data streams to different UTs 110. The RF transceivers convert digital signals into RF signals and vice versa, facilitating wireless communication. Backhaul connections, such as fiber optic or microwave links, connect the cell towers 114 to the core network 230. The T-RAN 210-1 performs several roles, such as managing network resources, performing radio resource management (RRM) (e.g., handovers, load balancing, and interference mitigation), etc.

The T-RAN 210-1 can establish TN downlink (TN-DL) channels 122 with UTs 110. The T-RAN 210-1 can establish and perform downlink communications over those TN-DL channels 122 through a series of well-coordinated steps. For example, a cell tower 114 broadcasts synchronization signals and system information blocks (SIBs) that enable the UTs 110 to detect and synchronize with the network. Once a UT 110 is connected, the cell tower 114 assigns radio resources for downlink transmission. Data from the core network 230 arrives at the cell tower 114 via the backhaul connection, where it is processed and modulated into RF signals by the RF transceivers. Advanced beamforming techniques are employed to direct these RF signals towards the UT 110, optimizing signal strength and minimizing interference. The UT 110 receives the RF signals through its antenna, demodulates them, and processes the data for the end-user. Throughout this process, the cell tower 114 continuously monitors the link quality and adjusts transmission parameters, such as power levels and modulation schemes, to ensure robust and efficient downlink communication.

The NT-RAN 210-2 includes satellite communication components, such as satellites 104 and ground stations 215 (e.g., gateways, NTN UTs (such as very small-aperture terminals, VSATs), etc.). In environments like the communication environment 200, the NT-RAN 210 is configured to extend the TN (e.g., 5G) coverage, such as to remote, rural, and underserved areas where terrestrial infrastructure is impractical or otherwise unavailable. The satellites 104 themselves include and facilitate communication features, such as transponders, antennas, beamforming capabilities, inter-satellite links, etc. Ground stations 215 effectively interface between the NT-RAN 210-2 and the terrestrial core network 230. For example, the ground stations 215 can handle data routing, frequency conversion, signal amplification, and/or other features.

The NT-RAN 210-2 can establish NTN downlink (NTN-DL) channels 212 with UTs 110. In the NT-RAN 210-2, downlink communications with UTs 110 via those NTN-DL channels 212 can involve sophisticated processes to leverage both NTN and TN (e.g., satellite and cellular) technologies. For example, downlink communications begin with data transmission from the core network 230 to a ground station 215, which then uplinks the data to a satellite 104. The satellite 104 receives the uplinked signals via its onboard antennas, and its transponders process and amplify the signals. The satellite 104 directs the downlink RF signals (e.g., using beamforming and/or other techniques) towards a UT’s 110 location, optimizing signal coverage and strength. The UT 110, equipped with a satellite-compatible antenna and receiver, captures the downlinked RF signals, demodulates them, and processes the data for an end-user. Throughout the communication process, the satellite 104 continuously adjusts its beam patterns and transmission parameters to maintain optimal link quality. In some implementations, inter-satellite links (ISLs) can be used to relay data directly between satellites 104.

As illustrated, both the T-RAN 210-1 and the NT-RAN 210-2 are in communication with a network operations center (NOC) 220. As noted above, other embodiments can operate in context of environments where the TN and NTN portions are loosely coordinating and do not both communicate with a same NOC 220. The NOC 220 generally serves as the centralized hub for overseeing the performance, health, and security of the entire network infrastructure (i.e., both the NTN and the TN portions of the network environment 200). For example, the NOC 220 includes network management systems (NMSs) to provide real-time dashboards, alerts, and control mechanisms for both the T-RAN 210-1 and the NT-RAN 210-2. The NOC 220 can use telemetry and protocols (e.g., Simple Network Management Protocol (SNMP)) to collect performance data (e.g., signal quality, traffic load, fault occurrences, etc.) from cell towers 114 in the T-RAN 210-1 and from satellites 104 and ground stations 215 in the NT-RAN 210-2. The NOC 220 can analyze the data to support proactive fault detection, performance optimization, configuration management, security management, and or other features.

As noted above, both the T-RAN 210-1 and the NT-RAN 210-2 are in communication with a core network 230. The core network 230 can be implemented as a software-defined infrastructure to manage and orchestrate the entire 5G ecosystem, including both the T-RAN 210-1 and the NT-RAN 210-2. The core network 230 can perform several roles, such as handling session management and mobility management, managing authentication and authorization processes, implementing network slicing, facilitating data routing and forwarding, overseeing policy control and charging, etc. In the 5G context, the core network 230 can be referred to as the 5G core (5GC).

The core network 220 also acts as a central hub to connect the T-RAN 210-1 and the NT-RAN 210-2 to one or more external data networks (illustrated generally as data network 240). The core network 230 and the data network 240 are connected via high-capacity, low-latency links that facilitate rapid and seamless data exchange. The data network 240 can include any suitable networks, such as the Internet, private enterprise networks, cloud services, content delivery networks (CDNs), etc. The data network 240 can also provide several services, such as web hosting, online applications, streaming services, cloud computing platforms, IoT ecosystems, enterprise VPNs, etc.

The illustrated architecture is intended generally to represent possible integration between NTN and TN infrastructures. For example, both the T-RAN 210-1 and the NT-RAN 210-2 are generally illustrated as including “RU/CU/DU” components, corresponding to radio unit (RU), distributed unit (DU), and central unit (CU) functions. Each RU is responsible for transmission and reception of radiofrequency signals and interfaces directly with antennas to convert between analog and digital signal spaces. In some disaggregated models, the RU is also responsible for lower physical (PHY) layer functions. Each DU is responsible for real-time, lower-layer baseband processing, such as higher physical layer (Layer 1) processing (e.g., error correction, modulation/demodulation, encryption/decryption, etc.), and some media access control (MAC) layer (in Layer 2). In some disaggregated models, the DU is also responsible for radio link control (RLC) functions. Each CU is responsible for higher-layer functions, packet data convergence protocol (PDCP), and radio resource control (RRC) layers. The CU can also be responsible for service data adaptation protocol (SDAP) functions, such as mapping quality of service (QoS) flows to data radio bearers (DRBs).

In some implementations, the T-RAN 210-1 and/or the NT-RAN 210-2 are architected according to open radio access network (O-RAN) principles and protocols. O-RAN is an architecture that seeks to standardize interfaces between RAN components to allow network operators to mix and match products from different vendors. O-RAN deployments tend to leverage disaggregation, artificial intelligence (AI), machine learning (ML), and/or other technologies for network optimization. For example, embodiments can implement the RU, DU, and CU functions as virtualized network functions (VNFs) with standardized network interfaces. Other embodiments can implement the RU, DU, and CU functions as containerized network functions (CNFs). Integration of O-RAN principles into such deployments can increase flexibility, scalability, and efficiency of the network architecture.

For the sake of simplicity, the illustrated environment 200 shows the RU/DU/CU components located together and in a particular RAN location. In particular, the in the RU/DU/CU components of the T-RAN 210-1 are shown between the cell towers 114 and the core network 230, and the RU/DU/CU components of the NT-RAN 210-2 are shown between in the ground stations 215 and the core network 230. However, different architectures can locate the RU, DU, and CU components in different ways. In some implementations, the RUs in the T-RAN 210-1 can be deployed at the cell towers 114 (or other base station sites) to handle transmission and reception between the cell towers 114 and the UTs 110, and the RUs in the NT-RAN 210-2 can be deployed as part of the satellite 104 payloads to handle transmission and reception between the satellites 104 and the UTs 110. The DUs in the T-RAN 210-1 can be deployed within a cell tower’s 114 physical site or in a more central location, such as in a nearby facility, and the DUs in the NT-RAN 210-2 can similarly be deployed on the satellite 104 or in a more central location, such as in or near a ground station 215. In one embodiment, the CUs in both the T-RAN 210-1 and the NT-RAN 210-2 are deployed in centralized ground-based data centers (e.g., in the NOC 220) to leverage computational resources and facilitate efficient network management. In some implementations that have regenerative satellites 104, certain of the RAN functions can be implemented in the satellites 104 (i.e., on the satellite payload). In one such implementation, the RU, DU, and CU functions are all be implemented in the satellites 104. In another such implementation, only the RU functions are implemented in the satellites 104, and the DU and CU functions are implemented in the NT-RAN 210-2. In another such implementation, the RU and DU functions are implemented in the satellites 104, and the CU functions are implemented in the NT-RAN 210-2.

As noted above, embodiments are considered with conditions in which there is overlap between NTN beam 108 coverage and TN cell 118 coverage. In some NTN deployments that use GEO satellites 104, beam 108 coverage areas may be relatively fixed, so that the overlap areas are substantially constant over time. However, other categories NTN deployments result in changing overlap areas over time. One category is NTN deployments having satellites 104 that employ beam hopping, or other dynamic beam pointing. For example, even for GEO satellites, determining which cells 118 are being overlapped by which beams 108 at any moment is dependent on the present temporal location relative to the beam-hopping schedule.

Another category is NTN deployments using NGSO satellites 104. For both LEO and MEO satellites 104, their non-geosynchronous orbits result in constant movement of their respective beam 108 coverage areas relative to the surface of the Earth. The precise locations of each satellite 104 at any time is provided by ephemeris data. The ephemeris data includes information on the satellite's 104 orbital elements, such as its semi-major axis, eccentricity, inclination, right ascension of the ascending node, argument of perigee, mean anomaly, and/or other parameters. Additionally, ephemeris data can include information on the satellite's 104 velocity, attitude, and other relevant parameters for accurate positioning. The ephemeris data can be defined and stored in formats standardized by organizations such as the International Global Navigation Satellite System (GNSS) Service (IGS).

To derive the future location of a particular beam 108 of a satellite 104, the ephemeris data can be used in conjunction with algorithms that calculate the satellite's 104 trajectory over time. The satellite's 104 future position and orientation can be predicted by inputting current ephemeris data into such algorithms. The beams 108 of a satellite 104 are directed based on its position and attitude. Thus, the predicted future position and orientation of the satellite 104 can be used to precisely calculate where each beam will be directed at any given future time.

Embodiments include a database 225 to store present ephemeris data, beam 108 data, and cell 118 data. Some implementations can store additional suitable data to support features described herein. The illustrated environment 200 shows a single database 225 in or coupled with the NOC 220. Other implementations can include any suitable number of databases 225 in any suitable location(s). For example, the database(s) 225 can be implemented in a remote server or the cloud (e.g., accessible via a data network 240 via the core network 230), in the core network 230, in one or more ground stations 215, etc.

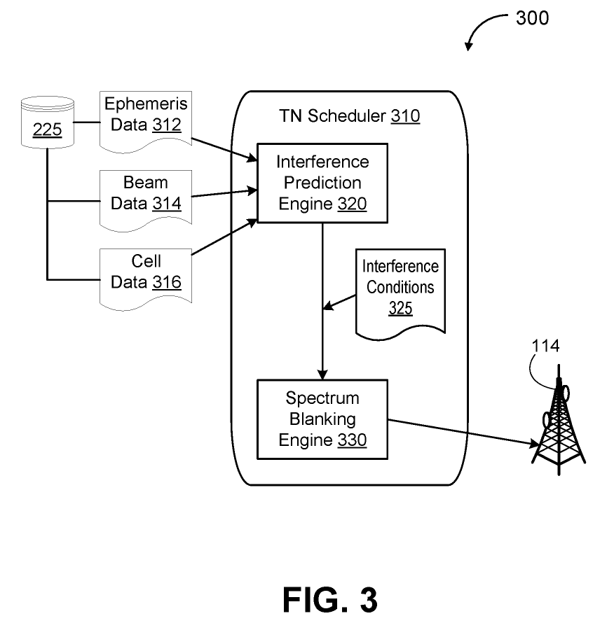

Though not explicitly shown, the environment 200 includes a TN scheduler. FIG. 3 shows a partial communication environment 300 that includes an illustrative embodiment of a terrestrial network (TN) scheduler 310, according to embodiments described herein. As illustrated, the TN scheduler 310 includes an interference prediction engine 320 and a spectrum blanking engine 330. The interference prediction engine 320 is in communication with the database(s) 225 described with reference to FIG. 2. As described there, the database(s) 225 maintain ephemeris data 312 and beam data 314 for the NTN portion of the overall communication environment and cell data 316 for the TN portion of the overall communication environment.

The interference prediction engine 320 is configured to predict, at any particular time, which cells 118 will be overlapping with which beams 108 at that time based on the ephemeris data 312, beam data 314, and cell data 316. As described above, the ephemeris data 312 is used to predict a location and orientation (attitude) of a satellite 104 (not shown) at the particular time based on the satellite’s trajectory, orbital dynamics, etc. and predefined algorithms.

The predicted location and orientation of the satellite 104 are used to determine the coverage area of its beam 108 (or coverage areas of its beam 108, if the satellite 104 concurrently projects multiple beams 108 at the particular time). In some implementations, the beam coverage areas are computed (predicted) only from predicted location and orientation of the satellite 104 and stored information about satellite 104 characteristics (e.g., the orientations of its antennas relative to its orientation, its altitude, the sizes of its spot beams, etc.). In other implementations, the beam data 314 includes some or all of the salient data for translating the predicted location and orientation of satellite(s) 104 into beam coverage areas. The beam data 314 also associates each beam 108 with a frequency band over which the beam 108 is communicating.

The cell data 316 associates cells 118 with geographic regions. In one implementation, the interference prediction engine 320 computes the beam coverage areas in a same coordinate system used to geographically define the cell coverage areas. In other implementations, the interference prediction engine 320 maps the computed beam coverage areas and/or the cell coverage areas into a common coordinate system. The interference prediction engine 320 generates a set of interference conditions 325 for each particular time, such that the interference conditions 325 indicate each instance in which a cell 118 is determined to be geographically overlapping with a beam 108.

In some cases, all beams 108 of the NTN infrastructure communicate in an NTN spectrum band that overlaps with spectrum used by cells 118 of the TN infrastructure. In such cases, all cases of overlap are treated as interference conditions 325. In other cases, only some beams 108 of the NTN infrastructure communicate in a frequency band that overlaps with spectrum used by cells 118 of the TN infrastructure. In some implementations for such cases, only the subset of beams 108 communicating over overlapping spectrum are considered in the above determination of interference conditions 325. For example, such implementations may only compute beam coverage areas for the subset of beams 108, and/or such implementations may only determine whether there is overlap involving the subset of beams 108. In other implementations for such cases, interference conditions 325 are computed for all beams 108 initially as candidate interference conditions 325. The candidate interference conditions 325 are then filtered into a final list of interference conditions 325 by removing any of the candidate interference conditions 325 in which there is no spectrum overlap.

Each interference condition 325 represents a condition in which there is some cell 118 for which, at some particular time, there is a beam 108 that occupies an overlapping geographical coverage area and communicates over an overlapping frequency band, thereby potentially causing co-channel interference. As such, for each interference condition 325, there is an implicated cell 118 and an implicated sub-band, which is the portion of the cell’s 118 TN spectrum overlapping with the beam’s 108 frequency band. The spectrum blanking engine 330 is configured, for each interference condition 325, to blank the implicated sub-band for the implicated cell 118.

The spectrum blanking engine 330 is configured to use physical resource block (PRB) blanking to implement the blanking of the implicated sub-band for the implicated cell 118. A PRB represents a smallest unit of resource allocation in the frequency domain. For example, a PRB can span 12 subcarriers over one time slot. For LTE, such a time slot can be 0.5 milliseconds. For 5G NR time slots, the slot duration depends on the sub-carrier spacing (SCS). For example, an SCS of 15 kHz yields a slot duration of 1 millisecond. PRB blanking involves deliberately deactivating (blanking) specific PRBs within an allocated bandwidth. For example, a cell 118 is allocated N MHz of bandwidth, which is divided into K PRBs, so that each PRB occupies a respective, disjoint N/K-MHz portion of the cell’s 118 allocated bandwidth.

For each interference condition 325, the spectrum blanking engine 330 identifies a set of implicated PRBs as the one or more PRBs corresponding to the implicated sub-band. The spectrum blanking engine 330 deactivates the implicated PRBs for the implicated cell 118 at the appropriate time. Thus, bandwidth allocations are scheduled to refrain from scheduling any data, control signals, or reference signals for transmission on the implicated PRBs for the implicated cell 118 at the corresponding time, thereby creating blank slots in the frequency domain.

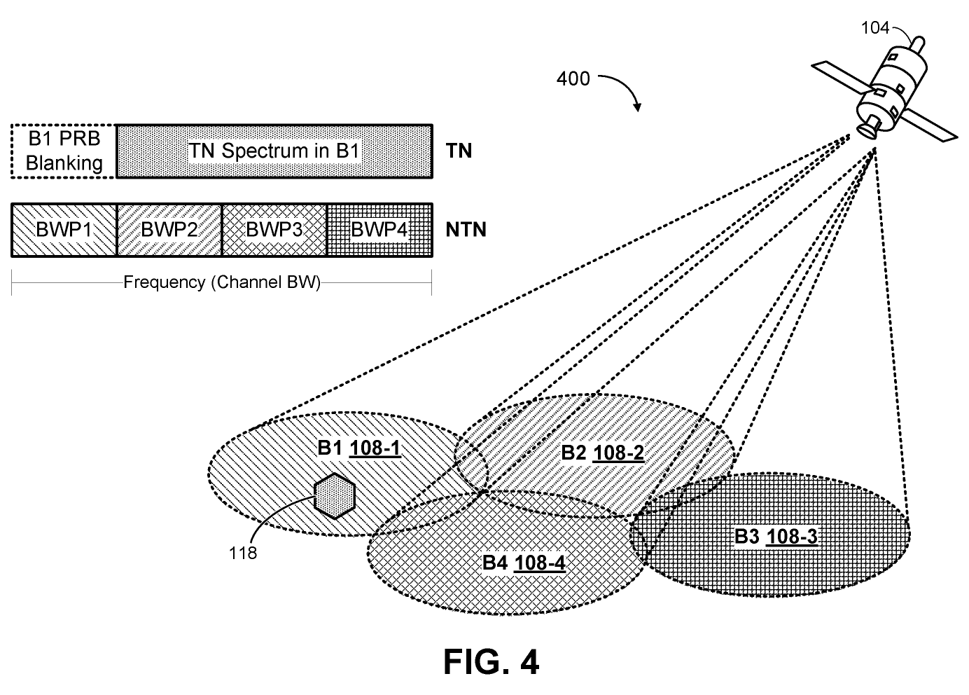

For example, FIG. 4 shows a graphical representation 400 of an interference condition 325 for a single cell 118 at a single time. As illustrated, a satellite 104 is projecting a four-color beam 108 pattern, such that four beams 108 are concurrently projected, each using a respective, disjoint bandwidth part (BWP) of allocated spectrum. In particular, beam 108-1 is allocated BWP1, beam 108-2 is allocated BWP2, beam 108-3 is allocated BWP3, and beam 108-4 is allocated BWP4. For the sake of simplicity, the illustrated scenario assumes that the entire TN spectrum is coextensive with the entire NTN spectrum and that each BWP is the same size, such that each of four BWPs of the NTN spectrum occupies a respective, disjoint quarter of the TN spectrum. In real-world implementations, there may be different amounts of overlap, different numbers of BWPs, different relative sizes of BWPs, etc.

For example, some current NTN specifications (e.g., Rel-17) support several bands, such as n256 (part of S-band at 2 GHz), n255 (part of L-band), n254 (DL on S-band and uplink on L-band), and n253 (L-band extension). All these bands overlap with so-called “Frequency Range 1” (FR1) bands, which cover frequencies from approximately 450 MHz to 7.125 GHz. Other NTN specifications (e.g., Rel-18) specifies additional “Frequency Range 2” (FR2) bands, such as n510, n511, and n512, which overlap with the Ka band. Future specifications plan to specify additional NTN bands in the Ku-band range.

As illustrated, the cell 118 is overlapped by beam 108-1, such that there is potential co-channel interference in the range of frequencies corresponding to BWP1. In association with this interference condition 325, embodiments blank those PRBs of the TN spectrum that overlap in frequency with BWP1. As such, the effective TN spectrum used for scheduling in cell 118 (and any in other cells overlapped completely by beam 108-1) corresponds to those PRBs that do not overlap with BWP1 (e.g., those substantially corresponding to BWP2, BWP3, and BWP4).

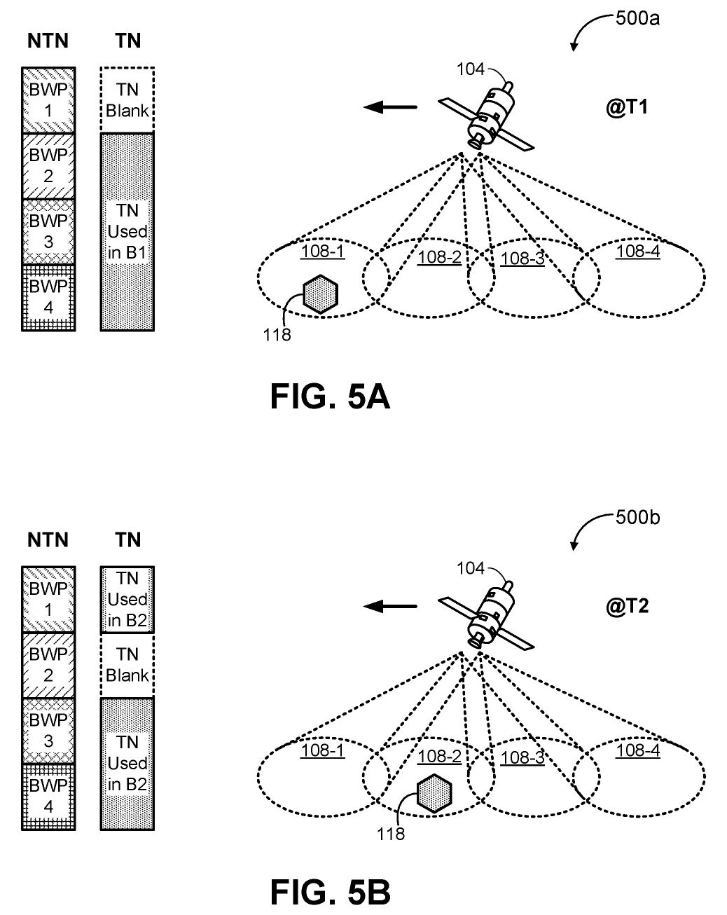

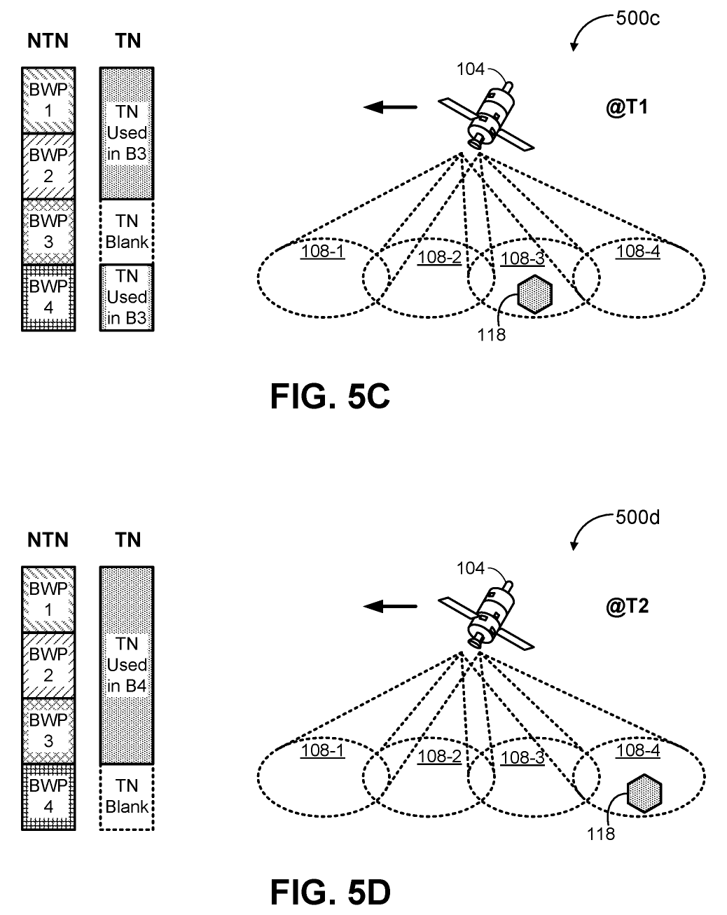

FIGS. 5A – 5D show graphical representations 500 of a changing interference condition 325 over time for a single cell 118 over four times. As illustrated, a satellite 104 is projecting a four-color beam 108 pattern, such that four beams 108 are concurrently projected, each using a respective, disjoint bandwidth part (BWP) of allocated spectrum. In particular, beam 108-1 is allocated BWP1, beam 108-2 is allocated BWP2, beam 108-3 is allocated BWP3, and beam 108-4 is allocated BWP4. For the sake of simplicity, the illustrated scenario assumes that the entire TN spectrum is coextensive with the entire NTN spectrum and that each BWP is the same size, such that each of four BWPs of the NTN spectrum occupies a respective, disjoint quarter of the TN spectrum.

Turning first to FIG. 5A, a first time period (T1) is represented in which beam 108-1 is overlapping with cell 118. As illustrated, PRB blanking is used to deactivate the portion of TN spectrum corresponding to BWP1, which is assigned to beam 108-1. In FIG. 5B, a second time period (T2) is represented in which the satellite 104 has moved so that beam 108-2 is now overlapping with cell 118. As illustrated, PRB blanking is used to deactivate the portion of TN spectrum corresponding to BWP2, which is assigned to beam 108-2. In FIG. 5C, a third time period (T3) is represented in which the satellite 104 has moved so that beam 108-3 is now overlapping with cell 118. As illustrated, PRB blanking is used to deactivate the portion of TN spectrum corresponding to BWP3, which is assigned to beam 108-3. In FIG. 5D, a fourth time period (T4) is represented in which the satellite 104 has moved so that beam 108-4 is now overlapping with cell 118. As illustrated, PRB blanking is used to deactivate the portion of TN spectrum corresponding to BWP4, which is assigned to beam 108-4.

Returning to FIG. 3, in some implementations, the spectrum blanking engine 330 performs TN spectrum scheduling to intentionally leave the implicated PRBs unused for transmission in accordance with the interference conditions 325. In other implementations, the spectrum blanking engine 330 directs RAN components, as appropriate, to perform the scheduling. As shown in FIG. 2, the T-RAN 210-1 includes DU and CU functions. The DUs can handle real-time implementation of PRB blanking by dynamically adjusting PRB allocation. The CUs can perform more macro-level functions, such as overseeing the coordination and optimization of PRB blanking policies across the network. In some implementations, the spectrum blanking engine 330 interfaces with the CUs to impact the PRB blanking at a higher level. In other implementations, the spectrum blanking engine 330 interfaces with the DUs to more directly control the PRB allocations. For example, different approaches of coordinating with the CUs, or bypassing the CUs to communicate with the DUs, can help to ensure that any PRB blanking directed by the spectrum blanking engine 330 does not conflict with other PRB blanking that may already be occurring at the direction of the CUs.

In some embodiments, in addition to blanking a particular PRB only for a particular cell 118, the spectrum blanking engine 330 performs additional coordination to determine whether also to blank some or all of those PRBs in adjacent cells 118. For example, coordinated multipoint (CoMP) protocols, inter-cell interference coordination (ICIC) protocols, and/or other protocols can be used to minimize similar interference from neighboring cells 118.

Referring to the environment 200 of FIG. 2, the TN scheduler 310 can be located in any suitable location or locations in the network. In some implementations, some or all components of the TN scheduler 310 are implemented in the NOC 220. In this location, the TN scheduler 310 can take advantage of the centralized location of the NOC 220, including its ability to monitor and control both the T-RAN 210-1 and NT-RAN 210-2. In some implementations, some or all components of the TN scheduler 310 are implemented in one or more CUs. For example, each CU can have a respective instance of the spectrum blanking engine 330. In some implementations, some or all components of the TN scheduler 310 are implemented in one or more DUs. For example, each DU can have a respective instance of the spectrum blanking engine 330. In some implementations, some or all components of the TN scheduler 310 are implemented in ground stations 215 and/or in cell towers 114. In some implementations, some or all components of the TN scheduler 310 are implemented in edge data centers. In some implementations, some or all components of the TN scheduler 310 are implemented in cloud-based management platforms.

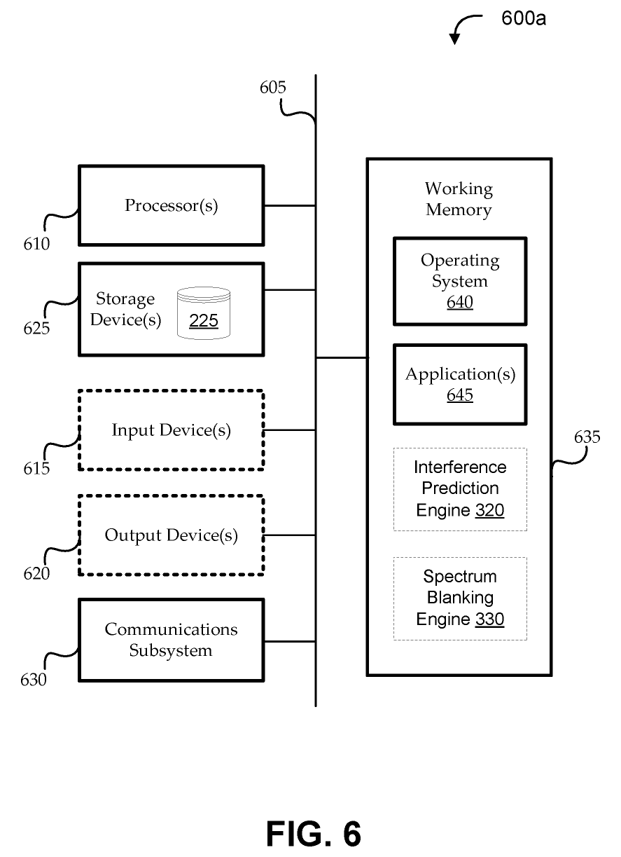

In some embodiments, components of the TN scheduler 310 can be implemented in a computational environment. FIG. 6 provides a schematic illustration of an embodiment of a computational system 600 that can implement various system components and/or perform various steps of methods provided by various embodiments. It should be noted that FIG. 6 is meant only to provide a generalized illustration of various components, any or all of which may be utilized as appropriate. FIG. 6, therefore, broadly illustrates how individual system elements may be implemented in a relatively separated or relatively more integrated manner.

The computational system 600 is shown including hardware elements that can be electrically coupled via a bus 605 (or may otherwise be in communication, as appropriate). The hardware elements may include one or more processors 610, including, without limitation, one or more general-purpose processors and/or one or more special-purpose processors (such as digital signal processing chips, graphics acceleration processors, video decoders, and/or the like). Optionally, embodiments of the computational system 600 can include one or more input devices 615, and/or one or more output devices 620. The input devices 615 can include user input devices (e.g., a mouse, a keyboard, remote control, touchscreen interfaces, audio interfaces, video interfaces, and/or the like) and/or machine input devices (e.g., computer-to-computer interfaces, such as wired and/or wireless input data ports). Similarly, the output devices 620 can include user output devices (e.g., display devices, printers, and/or the like), and/or machine input devices (e.g., computer-to-computer interfaces, such as wired and/or wireless output data ports).

The computational system 600 may further include (and/or be in communication with) one or more non-transitory storage devices 625, which can comprise, without limitation, local and/or network accessible storage, and/or can include, without limitation, a disk drive, a drive array, an optical storage device, a solid-state storage device, such as a random-access memory (“RAM”), and/or a read-only memory (“ROM”), which can be programmable, flash-updateable and/or the like. Such storage devices may be configured to implement any appropriate data stores, including, without limitation, various file systems, database structures, and/or the like. In some embodiments, the storage devices 625 include memory for storing ephemeris data 312, beam data 314, cell data 316, interference conditions 325, and/or other information used by embodiments to implement features described herein. For example, the storage devices 625 can include database(s) 225.

The computational system 600 can also include a communications subsystem 630, which can include, without limitation, a modem, a network card (wireless or wired), an infrared communication device, a wireless communication device, and/or a chipset (such as a Bluetooth*** ERROR: No Symbol mapping for puaHex=00E4. Looks like ™ may have been intended. *** device, an 802.11 device, a WiFi device, a WiMax device, cellular communication device, etc.), and/or the like. Depending on where in the network the computational system 600 is deployed, the communications subsystem 630 can include any suitable hardware and/or software components for communicating with other salient portions of the network.

The computational system 600 further includes a working memory 635, which can include a RAM or ROM device, as described herein. The computational system 600 also can include software elements, shown as currently being located within the working memory 635, including an operating system 640, device drivers, executable libraries, and/or other code, such as one or more application programs 645, which may include computer programs provided by various embodiments, and/or may be designed to implement methods, and/or configure systems, provided by other embodiments, as described herein. Merely by way of example, one or more procedures described with respect to the method(s) discussed herein can be implemented as code and/or instructions executable by a computer (and/or a processor within a computer); in an aspect, then, such code and/or instructions can be used to configure and/or adapt a general-purpose computer (or other device) to perform one or more operations in accordance with the described methods. As illustrated, the operating system 640 and the working memory 635 can be used in conjunction with the one or more processors 610 to implement the some or all of the interference prediction engine 320 and/or the spectrum blanking engine 330.

A set of these instructions and/or codes can be stored on a non-transitory (or non-transient) computer-readable storage medium, such as the non-transitory storage device(s) 625 described above. In some cases, the storage medium can be incorporated within a computer system, such as computational system 600. In other embodiments, the storage medium can be separate from a computer system (e.g., a removable medium, such as a compact disc), and/or provided in an installation package, such that the storage medium can be used to program, configure, and/or adapt a general-purpose computer with the instructions/code stored thereon. These instructions can take the form of executable code, which is executable by the computational system 600 and/or can take the form of source and/or installable code, which, upon compilation and/or installation on the computational system 600 (e.g., using any of a variety of generally available compilers, installation programs, compression/decompression utilities, etc.), then takes the form of executable code.

In some embodiments, the computational system 600 implements a portion of a system for communicating a data signal in a wireless communication network, as described herein. The non-transitory storage device(s) 625 can have instructions stored thereon, which, when executed, cause the processor(s) 610, for each of a number of designated times, to implement the interference prediction engine to: predict a location and orientation for a satellite of the NTN at the designated time; compute a set of beam coverage areas corresponding to a set of beams being projected by the satellite at the designated time based on the predicted location and orientation; and determine a set of interference conditions for the designated time, such that each interference condition corresponds to an instance in which a cell coverage area of an implicated cell of a plurality of cells of the TN is overlapped by one or more of the set of beam coverage areas and in which a frequency range assigned to the one or more of the set of beam coverage areas overlaps with a frequency range of the implicated cell to form one or more implicated sub-bands. The instructions, when executed, can further cause the processor(s) 610, for each of the number of designated times, to implement the spectrum blanking engine to schedule TN bandwidth resources to deactivate communications in the implicated one or more sub-bands in the implicated cell in the designated time.

It will be apparent to those skilled in the art that substantial variations may be made in accordance with specific requirements. For example, customized hardware can also be used, and/or particular elements can be implemented in hardware, software (including portable software, such as applets, etc.), or both. Further, connection to other computing devices, such as network input/output devices, may be employed.

As mentioned above, in one aspect, some embodiments may employ a computer system (such as the computational system 600) to perform methods in accordance with various embodiments of the invention. According to a set of embodiments, some or all of the procedures of such methods are performed by the computational system 600 in response to processor 610 executing one or more sequences of one or more instructions (which can be incorporated into the operating system 640 and/or other code, such as an application program 645) contained in the working memory 635. Such instructions may be read into the working memory 635 from another computer-readable medium, such as one or more of the non-transitory storage device(s) 625. Merely by way of example, execution of the sequences of instructions contained in the working memory 635 can cause the processor(s) 610 to perform one or more procedures of the methods described herein.

The terms “machine-readable medium,” “computer-readable storage medium” and “computer-readable medium,” as used herein, refer to any medium that participates in providing data that causes a machine to operate in a specific fashion. These mediums may be non-transitory. In an embodiment implemented using the computational system 600, various computer-readable media can be involved in providing instructions/code to processor(s) 610 for execution and/or can be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 625. Volatile media include, without limitation, dynamic memory, such as the working memory 635. Common forms of physical and/or tangible computer-readable media include, for example, a floppy disk, a flexible disk, hard disk, magnetic tape, or any other magnetic medium, a CD-ROM, any other optical medium, any other physical medium with patterns of marks, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 610 for execution. Merely by way of example, the instructions may initially be carried on a disk of a remote computer. The remote computer can load the instructions into its dynamic memory and send the instructions as signals over a transmission medium to be received and/or executed by the computational system 600. The communications subsystem 630 (and/or components thereof) generally will receive signals, and the bus 605 then can carry the signals (and/or the data, instructions, etc., carried by the signals) to the working memory 635, from which the processor(s) 610 retrieves and executes the instructions. The instructions received by the working memory 635 may optionally be stored on a non-transitory storage device 625 either before or after execution by the processor(s) 610.

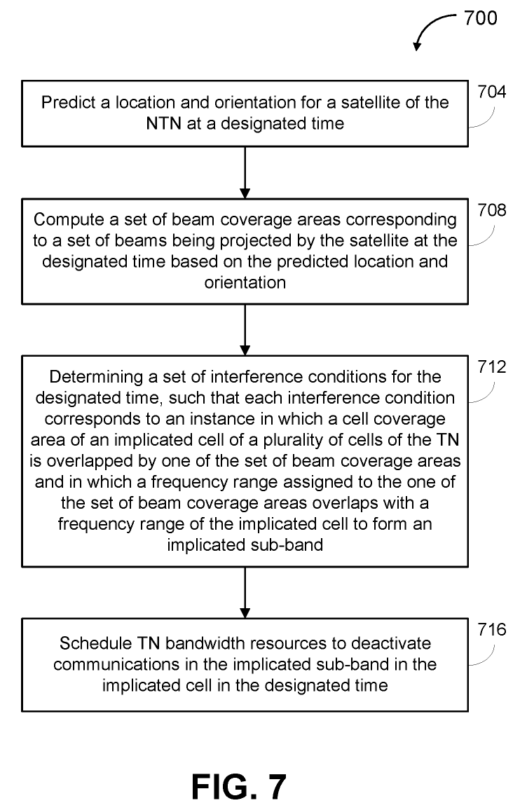

FIG. 7 shows a flow diagram of an illustrative method 700 for mitigating non-terrestrial network (NTN) downlink co-channel interference on a terrestrial network (TN) downlink. Embodiments begin at stage 704 by predicting (e.g., based on ephemeris data for the NTN) a location and orientation for a satellite of the NTN at a designated time. At stage 708, embodiments can compute a set of beam coverage areas corresponding to a set of beams being projected by the satellite at the designated time based on the predicted location and orientation. For example, at each designated time, one or more satellites of the NTN can project one or more beams each. Thus, although the method 700 is stated for a single satellite in a single designated time, embodiments of the method 700 can be extended for any number of satellites, any number of beams, any number of designated times, etc.

At stage 712, embodiments can determine a set of interference conditions for the designated time. As described herein, each interference condition corresponds to an instance in which a cell coverage area of an implicated cell of a plurality of cells of the TN is overlapped by one or more of the set of beam coverage areas and in which a frequency range assigned to the one of the set of beam coverage areas overlaps with a frequency range of the implicated cell to form one or more implicated sub-bands. In some embodiments, the determining in stage 712 includes first determining a plurality of candidate interference conditions, such that each candidate interference condition corresponds to an instance in which a cell coverage area of an implicated cell of a plurality of cells of the TN is overlapped by one or more of the set of beam coverage areas; and second determining the set of interference conditions as those of the plurality of candidate interference conditions for which a frequency range assigned to the one or more of the set of beam coverage areas overlaps with a frequency range of the implicated cell to form the one or more implicated sub-bands. In some embodiments, the determining in stage 712 incudes mapping the cell coverage areas of the plurality of cells of the TN and/or the beam coverage areas of the set of beams to a common coordinate system; and determining, for each cell of the plurality of cells, whether the cell coverage area of the cell is overlapped by any of the set of beam coverage areas in the common coordinate system based on the mapping.

At stage 716, embodiments can schedule TN bandwidth resources to deactivate communications in the implicated sub-band(s) in the implicated cell in the designated time. In some embodiments the scheduling at stage 716 includes determining a set of physical resource blocks of the TN bandwidth resources that corresponds to the implicated sub-band(s) and blanking the set of physical resource blocks for the implicated cell in the designated time.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered.

What is claimed is:

1. A method for mitigating non-terrestrial network (NTN) downlink co-channel interference on a terrestrial network (TN) downlink, the method comprising:
predicting, based on ephemeris data for the NTN, a location and orientation for a satellite of the NTN at a designated time;
computing a set of beam coverage areas corresponding to a set of beams being projected by the satellite at the designated time based on the predicted location and orientation;
determining a set of interference conditions for the designated time, such that each interference condition corresponds to an instance in which a cell coverage area of an implicated cell of a plurality of cells of the TN is overlapped by one or more of the set of beam coverage areas and in which a frequency range assigned to the one of the set of beam coverage areas overlaps with a frequency range of the implicated cell to form one or more implicated sub-bands; and
scheduling TN bandwidth resources to deactivate communications in the one or more implicated sub-band in the implicated cell in the designated time.

2. The method of claim 1, wherein the scheduling comprises:
determining a set of physical resource blocks of the TN bandwidth resources that corresponds to the one or more implicated sub-band; and
blanking the set of physical resource blocks for the implicated cell in the designated time.

3. The method of claim 1, wherein the determining the set of interference conditions comprises:
first determining a plurality of candidate interference conditions, such that each candidate interference condition corresponds to an instance in which a cell coverage area of an implicated cell of a plurality of cells of the TN is overlapped by at least one of the set of beam coverage areas; and
second determining the set of interference conditions as those of the plurality of candidate interference conditions for which a frequency range assigned to the one or more of the set of beam coverage areas overlaps with a frequency range of the implicated cell to form the one or more implicated sub-bands.

4. The method of claim 1, wherein the determining the set of interference conditions comprises:
mapping the cell coverage areas of the plurality of cells of the TN and/or the beam coverage areas of the set of beams to a common coordinate system; and
determining, for each cell of the plurality of cells, whether the cell coverage area of the cell is overlapped by any of the set of beam coverage areas in the common coordinate system based on the mapping.

5. The method of claim 1, wherein:
the satellite is one of a plurality of satellites of the NTN;
the predicting comprises predicting, based on the ephemeris data for the NTN, respective locations and orientations for each of the plurality of satellites at the designated time;
the computing comprises computing a plurality of beam coverage areas corresponding to a plurality of beams being projected by the plurality of satellites at the designated time based on the predicted respective locations and orientations; and
the determining the interference conditions comprises determining a plurality of interference conditions for the designated time, such that each interference condition corresponds to an instance in which a cell coverage area of an implicated cell of the plurality of cells is overlapped by one or more of the plurality of beam coverage areas and in which a frequency range assigned to the one or more of the plurality of beam coverage areas overlaps with a frequency range of the implicated cell to form an implicated sub-band.

6. The method of claim 1, wherein the designated time is one of a plurality of designated times, and further comprising:
performing the predicting the location and orientation, the computing the set of beam coverage areas, the determining the set of interference conditions, and the scheduling the TN bandwidth resources for each of the plurality of designated times.

7. A terrestrial network (TN) scheduler for mitigating non-terrestrial network (NTN) downlink co-channel interference on a terrestrial network (TN) downlink, the TN scheduler comprising:
an interference prediction engine configured, for each of a plurality of designated times, to:
predict a location and orientation for a satellite of the NTN at the designated time;
compute a set of beam coverage areas corresponding to a set of beams being projected by the satellite at the designated time based on the predicted location and orientation; and
determine a set of interference conditions for the designated time, such that each interference condition corresponds to an instance in which a cell coverage area of an implicated cell of a plurality of cells of the TN is overlapped by one or more of the set of beam coverage areas and in which a frequency range assigned to the one of the set of beam coverage areas overlaps with a frequency range of the implicated cell to form one or more implicated sub-bands; and
a spectrum blanking engine configured to schedule TN bandwidth resources to deactivate communications in the one or more implicated sub-bands in the implicated cell in the designated time.

8. The TN scheduler of claim 7, wherein:
the interference prediction engine is communicatively coupled with a non-transitory memory having stored, ephemeris data, beam data, and cell data;
the interference prediction engine is configured to predict the location and orientation based on the ephemeris data; and
the interference prediction engine is configured to determine the set of interference conditions based on the beam data and the cell data.

9. The TN scheduler of claim 8, wherein:
the interference prediction engine is configured to compute the set of beam coverage areas based on the beam data.

10. The TN scheduler of claim 7, wherein the spectrum blanking engine is configured to schedule the TN bandwidth resources scheduling by:
determining a set of physical resource blocks of the TN bandwidth resources that corresponds to the one or more implicated sub-bands; and
blanking the set of physical resource blocks for the implicated cell in the designated time.

11. The TN scheduler of claim 10, wherein the blanking comprises:
directing one or more centralized units (CUs) of a terrestrial radio access network (T-RAN) not to use the set of physical resource blocks for any transmissions in the implicated cell in the designated time.

12. The TN scheduler of claim 10, wherein the blanking comprises:
directing one or more distributed units (DUs) of a terrestrial radio access network (T-RAN) not to use the set of physical resource blocks for any transmissions in the implicated cell in the designated time.

13. The TN scheduler of claim 7, wherein the interference prediction engine is configured to determine the set of interference conditions by:
first determining a plurality of candidate interference conditions, such that each candidate interference condition corresponds to an instance in which a cell coverage area of an implicated cell of a plurality of cells of the TN is overlapped by one or more of the set of beam coverage areas; and
second determining the set of interference conditions as those of the plurality of candidate interference conditions for which a frequency range assigned to the one or more of the set of beam coverage areas overlaps with a frequency range of the implicated cell to form the one or more implicated sub-bands.

14. The TN scheduler of claim 7, wherein the interference prediction engine is configured to determine the set of interference conditions by:
mapping the cell coverage areas of the plurality of cells of the TN and/or the beam coverage areas of the set of beams to a common coordinate system; and
determining, for each cell of the plurality of cells, whether the cell coverage area of the cell is overlapped by any of the set of beam coverage areas in the common coordinate system based on the mapping.

15. A system for mitigating non-terrestrial network (NTN) downlink co-channel interference on a terrestrial network (TN) downlink, the system comprising:
one or more processors;
a non-transitory database having stored thereon ephemeris data, beam data, and cell data; and
a non-transitory processor-readable medium having instructions stored thereon which, when executed, cause the one or more processors to perform steps comprising, for each of a plurality of designated times:
predicting a location and orientation for a satellite of the NTN at the designated time;
computing a set of beam coverage areas corresponding to a set of beams being projected by the satellite at the designated time based on the predicted location and orientation;
determining a set of interference conditions for the designated time, such that each interference condition corresponds to an instance in which a cell coverage area of an implicated cell of a plurality of cells of the TN is overlapped by one or more of the set of beam coverage areas and in which a frequency range assigned to the one of the set of beam coverage areas overlaps with a frequency range of the implicated cell to form one or more implicated sub-bands; and
scheduling TN bandwidth resources to deactivate communications in the one or more implicated sub-bands in the implicated cell in the designated time.

16. The system of claim 15, wherein:
the predicting the location and orientation is based on the ephemeris data; and
the determining the set of interference conditions based on the beam data and the cell data.

17. The system of claim 15, wherein the scheduling the TN bandwidth resources scheduling comprises:
determining a set of physical resource blocks of the TN bandwidth resources that corresponds to the implicated sub-band; and
blanking the set of physical resource blocks for the implicated cell in the designated time.

18. The system of claim 17, wherein:
the one or more processors are communicatively coupled with a terrestrial radio access network (T-RAN) of the TN; and
the blanking comprises directing one or more centralized units (CUs) and/or distributed units (DUs) of the T-RAN not to use the set of physical resource blocks for any transmissions in the implicated cell in the designated time.

19. The system of claim 15, wherein the determining the set of interference conditions comprises:
first determining a plurality of candidate interference conditions, such that each candidate interference condition corresponds to an instance in which a cell coverage area of an implicated cell of a plurality of cells of the TN is overlapped by one or more of the set of beam coverage areas; and
second determining the set of interference conditions as those of the plurality of candidate interference conditions for which a frequency range assigned to the one or more of the set of beam coverage areas overlaps with a frequency range of the implicated cell to form the one or more implicated sub-bands.

20. The system of claim 15, wherein the determining the set of interference conditions comprises:
mapping the cell coverage areas of the plurality of cells of the TN and/or the beam coverage areas of the set of beams to a common coordinate system; and
determining, for each cell of the plurality of cells, whether the cell coverage area of the cell is overlapped by any of the set of beam coverage areas in the common coordinate system based on the mapping.
